(19) United States
(12) Patent Application Publication
(10) Pub. No.: US 2012/0107535 A1
(43) Pub. Date: May 3, 2012

(54) ORNAMENTAL ARTICLE

(75) Inventors: Yuuichi Nishigaki, Kyoto-shi (JP); Akihiko Kataoka, Kyoto-shi (JP); Masaharu Takiyama, Kyoto-shi (JP)

(73) Assignee: KYOCERA CORPORATION, Kyoto-shi, Kyoto (JP)

(21) Appl. No.: 13/381,067

(22) PCT Filed: Mar. 31, 2010
(86) PCT No.: PCT/JP2010/055876

§ 371 Date: Dec. 27, 2011

(30) Foreign Application Priority Data
Jul. 3, 2009 (JP) 2009-177479

(51) Int. Cl. B32B 3/10; B32B 3/02; B44F 5/00

(52) U.S. Cl. 428/34.1; 428/195.1

(57) ABSTRACT

In ornamental articles which make it difficult for other people to visually recognize a symbol or symbol string, required is an ornamental article which makes it easy to visually recognize even solely when a specific condition is satisfied, and also permits smooth alignment. The ornamental article comprises a first ornament and a second ornament each having a symbol or symbol string laid out across at least two surfaces adjacent to each other. When one surface of the first ornament having a part of the symbol or symbol string laid out thereon, and one surface of the second ornament having a part of the symbol or symbol string laid out thereon are adjacent to each other, the symbol or symbol string is displayed recognizably from the one surface of the first ornament to the one surface of the second ornament.

### TECHNICAL FIELD

The present invention relates to an ornamental article.

### BACKGROUND ART

Among ornamental articles such as a pair of pendants and a pair of rings, there have been conventionally ones configured to form a specific pattern or symbol (string) by combining two ornaments. They aim to make it difficult for other people to visually recognize the pattern or symbol (string).

For example, patent document 1 discloses a pair of rings consisting of an inner ring and an outer ring fitted thereinto. A part of the symbol (string) and the rest thereof are respectively carved in the inner ring and the outer ring of the pair of rings. The symbol string is displayed by the fit between the inner ring and the outer ring.

Patent document 2 discloses a pair of rings in which one ring and the other ring have an ornament partially formed on the outer peripheral surface of the one ring and on the outer peripheral surface of the other ring. In the pair of rings, the ornament is displayed across both rings by arranging them so that their respective outer peripheral surfaces are in contact with each other.

### PRIOR ART DOCUMENTS

### Patent Documents

Patent Document 1: Japanese Unexamined Patent Publication No. 2003-299511
Patent Document 2: Japanese Utility Model Registration No. 3102413

### SUMMARY OF THE INVENTION

### Problems to be Solved by the Invention

However, in each of the pairs of rings disclosed in the patent documents 1 and 2, it might be difficult even for ones who wear them to singly recognize the symbol or symbol string. It might also be difficult to smoothly align the symbols or symbol strings respectively formed on the two rings.

An object of the present invention to provide a pair of ornaments which make it easier to visually recognize even singly under a specific condition, and permit smooth alignment therebetween.

### Means for Solving the Problems

An ornamental article includes a first ornament and a second ornament each having a symbol or symbol string laid out across at least two surfaces adjacent to each other. In such an arrangement that one surface of the first ornament having a part of the symbol or symbol string laid out thereon, and one surface of the second ornament having a part of the symbol or symbol string laid out thereon are adjacent to each other, the symbol or symbol string is displayed recognizably from the one surface of the first ornament to the one surface of the second ornament.

### Effect of the Invention

The present invention makes it difficult for other people to visually recognize the symbol or symbol string, and allows the symbol or symbol string to be visually recognized as a whole, from a specific direction even in the single ornament, thereby facilitating alignment between the symbols (strings) of the two rings.

Similar effects can be produced by the combination of two or more ornaments.

### BRIEF DESCRIPTION OF THE DRAWINGS

FIG. 1 is a schematic view in a first embodiment of an ornamental article of the present invention: FIG. 1(a) is a perspective view of a single ornament; and FIG. 1(b) is a front view of a combined ornament;

FIG. 2 is a schematic view in second and third embodiments of the ornamental article of the present invention: FIG. 2(a) is a perspective view of a single ornament; and FIG. 2(b) is a front view of a combined ornament; and

FIG. 3 is a schematic view in a fourth embodiment of an ornamental article of the present invention: FIG. 3(a) is a perspective view of a single ornament; and FIG. 3(b) is a front view of a combined ornament.

### EMBODIMENTS FOR CARRYING OUT THE INVENTION

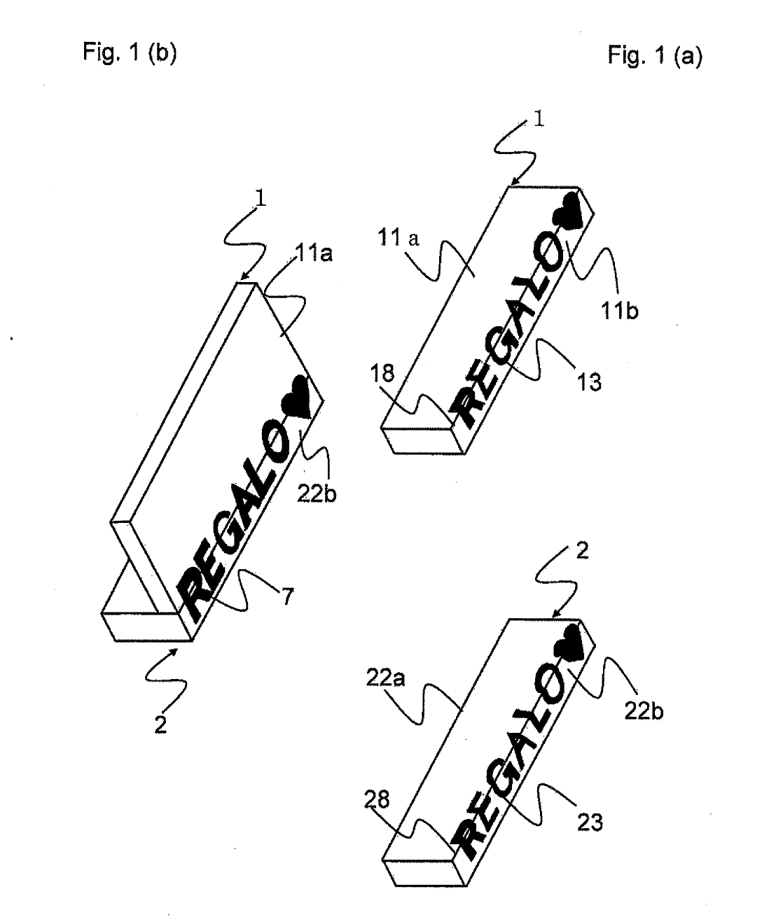

One embodiment of the ornamental article of the present invention is made up of a first ornament 1 and a second ornament 2 having an entirety 7 of a symbol or symbol string laid out across at least two surfaces adjacent to each other, as shown in FIG. 1. When the first ornament 1 and the second ornament 2 are arranged so that one surface 11a of the first ornament 1 having a part of the symbol or symbol string laid out thereon, and one surface 22b of the second ornament 2 having a part of the symbol or symbol string laid out thereon are adjacent to each other, the symbol or symbol string are displayed recognizably as the entirety 7 in regions (11a and 22b) extended from the one surface of the first ornament 1 to the one surface of the second ornament 2. In the present embodiment, the first ornament 1 and the second ornament 2 are arranged so that the surface 11a and the surface 22b are flush with each other. Thus, it is suitable to include the regions where the surface 11a and the surface 22b are flush with each other.

The symbol is a symbol (character), and the symbol string is a string of a plurality of combined symbols (characters).

In the present embodiment, an identical symbol string 3 is laid out on the first ornament 1 and the second ornament 2. A lower part of the symbol string 3 is laid out on a contact surface 11b of the first ornament 1, and an upper part of the symbol string 3 is laid out on a contact surface 22a of the second ornament 2. Thus, the complete display object 7 can be displayed by the symbol string 3 of the first ornament 1 and the symbol string 3 of the second ornament 2.

In the present specification, the complete display object 7 is formed recognizably as the symbol or symbol string by combining a part of the symbol (string) and the rest. Even when the symbol string 3 of the first ornament 1 and the symbol string 3 of the second ornament 2 are different, so long as a part thereof shows the symbol (string), this can be regarded as the complete display object 7.

Further, so long as the vertical directions of the individual symbols (strings) in the first ornament 1 and the second ornament 2 are opposite each other, both can be distinguished. This is suitable for preventing an erroneous change of ownership.

The complete display object 7 is clearly displayed without distortion by being displayed recognizably in the regions flush with each other.

In the present embodiment, at least two surfaces adjacent to each other in the first ornament 1 and the second ornament 2 are, for example, substantially perpendicular to each other. This makes it difficult for other people to visually recognize the symbol or symbol string 3 on the single ornaments of the first ornament 1 and the second ornament 2. For example, when at least two surfaces adjacent to each other have an obtuse angle, it is easier for other people to visually recognize the symbol or symbol string. When at least two surfaces adjacent to each other have an acute angle, it is difficult even for ones who wear the ornaments to visually recognize the symbol or symbol string. Additionally, the complete display object 7 is displayed as the continuous symbol or symbol string 3, thereby presenting an excellent aesthetic appearance.

Furthermore, it is preferable to have a line-intersection portion formed by the at least two surfaces adjacent to each other. This makes it difficult for other people to visually recognize the symbol or symbol string 3 on the single ornaments of the first ornament 1 and the second ornament 2.

For example, when the line-intersection portion 8 of inner and outer side surfaces is unclear and is a large round surface, it is difficult to divide the boundary between the individual surfaces, thus making it easier for other people to visually recognize the symbol or symbol string 3.

Additionally, the complete display object 7 is displayed as the continuous symbol, thereby presenting an excellent aesthetic appearance.

In the present embodiment, each of the first ornament 1 and the second ornament 2 is a polyhedron. Specifically, the polyhedron is a substantially rectangular parallelepiped or substantially cube.

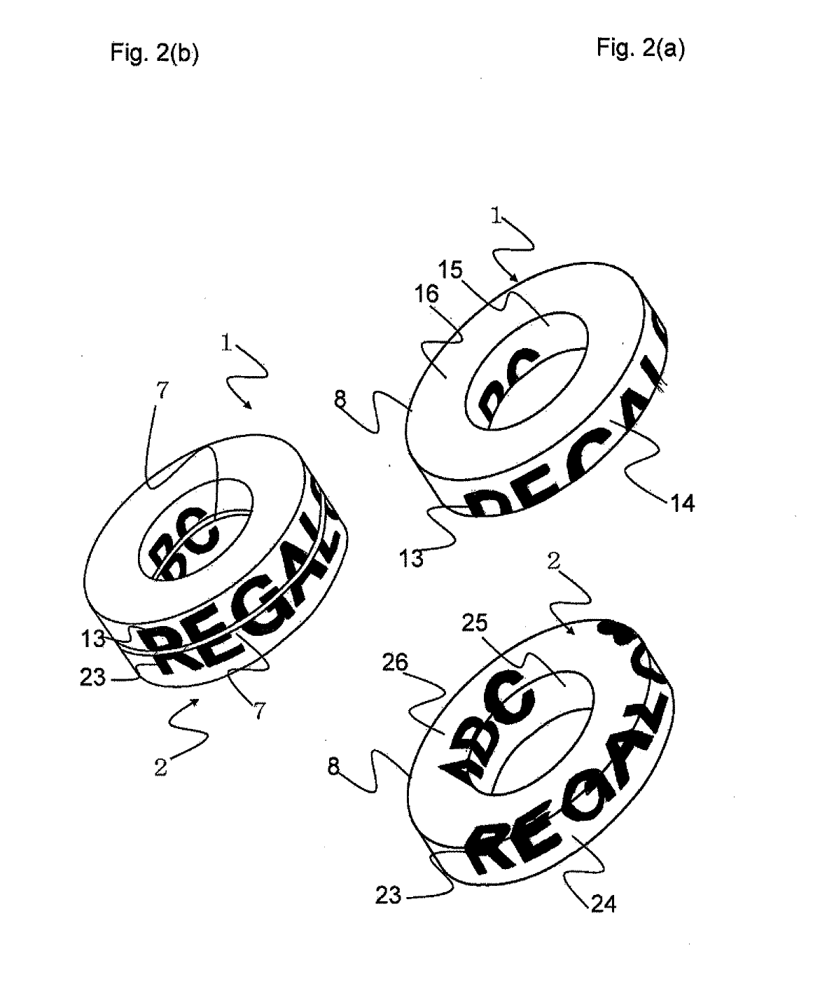

In a second embodiment of the ornamental article of the present invention, as shown in FIG. 2, each of the first ornament 1 and the second ornament 2 includes an outward surface (14, 24), an inward surface (15, 25), and a side surface (16, 26) located between the outward surface and the inward surface. Each of the first and second ornaments is an annular body having a symbol or symbol string laid out across at least two surfaces, namely, the outward surface and the side surface. When the outward surface 14 of the first ornament 1 and the outward surface 24 of the second ornament 2 are arranged adjacent to each other, the symbol or symbol string 3 is displayed recognizably from the outward surface 14 of the first ornament 1 to the outward surface 24 of the second ornament 2. In the present embodiment, the first ornament 1 and the second ornament are in contact with each other so that the outward surface 14 and the outward surface 24 of the second ornament 2 are flush with each other.

In the present embodiment, the outer diameters of the outward surfaces of the first ornament 1 and the second ornament 2 are preferably equivalent to each other. This allows the complete display object 7 to be displayed as the continuous symbol or symbol string 3, thereby presenting an excellent aesthetic appearance.

In a third embodiment of the ornamental article of the present invention, each of the first ornament 1 and the second ornament 2 includes an outward surface (14, 24), an inward surface (15, 25), and a side surface (16, 26) located between the outward surface and the inward surface. Each of the first and second ornaments is an annular body having a symbol or symbol string laid out across at least two surfaces, namely, the outward surface and the side surface. When the inward surface 15 of the first ornament 1 and the inward surface 25 of the second ornament 2 are arranged so as to be adjacent to each other, the symbol or symbol string is displayed recognizably from the inward surface 15 of the first ornament 1 to the inward surface 25 of the second ornament 2. In the present embodiment, the first ornament 1 and the second ornament are in contact with each other so that the inward surface 15 and the inward surface 25 of the second ornament are flush with each other.

In the present embodiment, the inner diameters of the inward surfaces of the first ornament 1 and the second ornament 2 are preferably equivalent to each other. This allows the entirety 7 to be displayed as the continuous symbol or symbol string 3, thereby presenting an excellent aesthetic appearance.

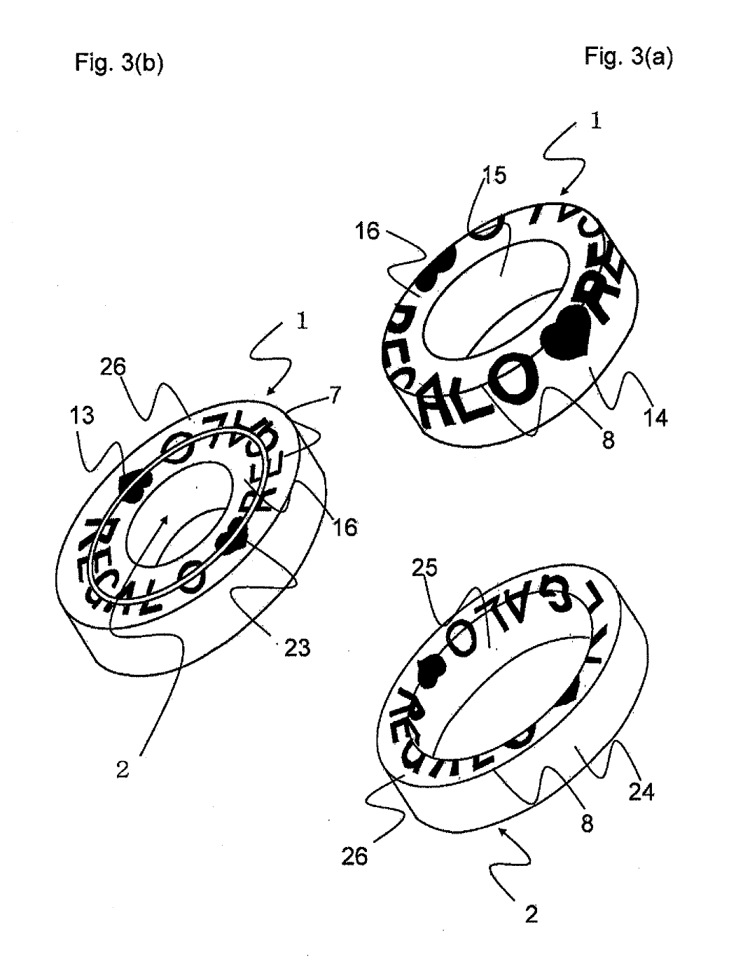

In a fourth embodiment of the ornamental article of the present invention, as shown in FIG. 3, each of the first ornament 1 and the second ornament 2 is an annular body including an outward surface (14, 24), an inward surface (15, 25), and a side surface (16, 26) located between the outward surface and the inward surface. The outer diameter of the first ornament 1 is not more than the inner diameter of the second ornament 2. In the first ornament 1, a symbol or symbol string is laid out across at least two surfaces, namely, the outward surface 14 and the side surface 16. In the second ornament 2, a symbol or symbol string is laid out across at least two surfaces, namely, the inward surface 25 and the side surface 26. When the outward surface 15 of the first ornament 1 and the inward surface 24 of the second ornament 2 are arranged oppositely, the symbol or symbol string is displayed recognizably as the entirety 7 from the side surface 16 of the first ornament 1 to the side surface 26 of the second ornament 2. In the present embodiment, the inner diameter of the first ornament 1 and the outer diameter of the second ornament 2 are substantially the same.

Furthermore, the width of the outward surface 14 of the first ornament 1 and the width of the inward surface 25 of the second ornament 2, which are brought into contact with each other, are preferably equivalent to each other. This allows the entirety 7 to be displayed as the continuous symbol or symbol string 3, thereby presenting an excellent aesthetic appearance.

Other embodiment of the ornamental article of the present invention is made up of a plurality of ornaments having a symbol or symbol string laid out across a plurality of surfaces adjacent to each other. When one surfaces of the plurality of ornaments having a part of the symbol or symbol string laid out thereon are arranged so as to be adjacent to each other, the symbol or symbol string is displayed recognizably on these surfaces adjacent to each other. In the present embodiment, these surfaces close to each other are arranged flush with each other.

Here, the symbol is as described above. That is, even when two or more ornaments are combined together, it is difficult for other people to visually recognize the symbol or symbol string 3. Even in the single ornaments, the symbol or symbol string 3 can be visually recognized as the entirety 7 from a specific direction, thus facilitating alignment between the symbols (symbol strings) 3 of the two.

In this case, the ornamental article is made of the plurality of ornaments (single ornaments), and therefore can also be referred to as a set of ornaments (a combined ornament).

Preferably, an upper part of the symbol or symbol string is laid out on the contact surface of the first ornament, and a lower part of the symbol or symbol string is laid out the contact surface of the second ornament.

Although here the upper part 3a and the lower part 3b of the symbol or symbol string 3 are divided only by two surfaces, they may be divided into a plurality of sections by a plurality of surfaces. This achieves mutual compensation for the entirety 7.

Preferably, the entire symbol is recognizably displayed on regions flush with each other. This allows the entirety 7 to be clearly displayed without distortion.

More preferably, the plurality of surfaces adjacent to each other are substantially perpendicular to each other and are displayed recognizably. This makes it difficult for other people to visually recognize the symbol or symbol string 3 on the first ornament 1 and the second ornament 2, as in the case of the first embodiment.

It is also preferable to include a line-intersection portion formed by the plurality of surfaces adjacent to each other. This makes it difficult for other people to visually recognize the symbols or symbol strings 3 of the single ornaments of the first ornament 1 and the second ornament 2.

Next, several embodiments of a method of manufacturing rings according to the present invention are described.

For example, platinum (Pt950), three kinds of 18-karat gold (white gold/yellow gold/pink gold) are mainly used as a material of the rings. It is possible to use any other materials capable of forming a mirror surface.

A material formed into a plate shape by striking in casting process is punched out in size and shape somewhat larger than the rings. This is machined into a product shape by press and cutting.

Alternatively, the product may be formed in the following manner. That is, a mold is obtained by rubber die blanking, and wax is poured into the rubber die. The wax having the same shape as the mold is taken out, and a plaster cast is made. The wax is then removed through melting and evaporation by applying heat. A molten base metal (gold, platinum, etc) is poured into the plaster cast and then cooled, resulting in the product having the same shape as the mold.

Alternatively, the product may be manufactured using a mold formed by vacuum plasma sintering. In the case of an inexpensive material, the product may be manufactured by die drawing process, followed by cutting. The outer diameter of the ring and the inner diameter thereof may have a relationship permitting a concentric circular arrangement.

As a leading example of the method of machining a symbol, there are cutting processing and laser processing.

The cutting processing method includes cutting and engraving into the symbol shape by using a rotary tool. The cutting processing may be carried out by inputting a program for a predetermined shape in a numerical control machining. Specific control conditions are as follows. Cemented carbide, single crystal diamond, sintered diamond, cubic boron nitride, alumina (corundum), silicon nitride, steel, or cermet is used as a tool material. As a cutting tool, a looter or the like is preferably used by setting so that a tool spindle speed is 100-40000 rpm, a feed rate is 0.1-1000 mm/sec, and a cutting depth is 0.01-1 mm.

The laser processing method includes melt processing into a predetermined shape by laser irradiation. Similarly to the cutting processing, the laser processing is carried out by inputting a program for the predetermined shape. Specific control conditions are as follows. A laser oscillator for performing the melt processing is set so that a voltage (power density) is 1-100 mV, a pulse width is 0.01-1 sec, and a pulse interval is 0.001 Hz to 100 MHz. In particular, the laser facilitates control of line thickness.

Mirror-like finishing is carried out by performing electro polishing or barreling, followed by buffing. The subsequent plating processing makes it easier to achieve a more excellent mirror surface.

The electro polishing conditions are set so that a liquid temperature is 5-150° C., a voltage is 100-200 V, a current is 1-10 A, and processing time is 10 sec to 3 hours.

The centrifugal or magnetic barreling conditions are set so that the media material is alumina, and the media has an average diameter of 0.3-1 μm. In a wet or dry barreling system, the rotational frequency is 1-10 rpm, the revolution frequency is 1-10 rpm, and the processing time is 10 sec to 3 hours.

The finish buffing conditions are as follows. The buff material is a natural fiber (cotton, hemp, linen, wool, silk, cashmere, asbestos, glass fiber, or the like), or chemical fiber (polyester-based synthetic fiber, polyamide-based synthetic fiber, cellulose-based half-synthetic fiber, protein-based half-synthetic fiber, cellulose-based regenerated fiber, glass fiber, carbon fiber, or the like). The rotational frequency of a buff rotor is 1000-40000 rpm. As abrasive, diamond, cubic boron nitride, silicon carbide, alumina corundum, chrome oxide, cerium oxide, iron oxide, siliceous limestone, or the like is used.

As a method of forming the symbol or symbol string (character or character string) 3 on the rings, the cutting processing or the laser processing or the plating processing is suitable. This is explained below.

The cutting processing and the laser processing are as described above. In the plating processing, rhodium-based, ruthenium-based, platinum-based, gold-based, paradigm-based, silver-based, copper-based, or nickel-based plating solution is suitable. Preferably, voltage is set to 200 V, current is set to 1 A, and processing time is set to 1 sec to 3 hours. Regarding control conditions, a plating thickness is 1 μm to several tens μm, and a plating material is rhodium plating. As a masking method, a masking resin is generally applied and plated. In particular, novolac resin is applied to a masking section, thereby facilitating selective plating. The plating using the masking also makes it easier to form the symbol 2.

Thus, the present invention provides the rings having a less fragile structure without design limitations, and making it difficult for other people to visually recognize the symbol or symbol string (character or character string).

### EXPLANATION OF REFERENCE NUMERALS

1: first ornament
2: second ornament
13, 23: symbols or symbol strings (characters or character strings)
14, 24: outward surfaces
15, 25: inward surfaces
16, 26: side surfaces
7: entirety
18, 28: line-intersection portions

1-20. (canceled)

21. An ornamental article, comprising:
a first ornament and a second ornament each having a symbol or symbol string laid out across at least two surfaces adjacent to each other, wherein
when one surface of the first ornament having a part of the symbol or symbol string laid out thereon, and one surface of the second ornament having a part of the symbol or symbol string laid out thereon are arranged so as to be adjacent to each other, the symbol or symbol string is displayed recognizably from the one surface of the first ornament to the one surface of the second ornament.

22. The ornamental article according to claim 21, wherein, in such an arrangement that the one surface of the first ornament and the one surface of the second ornament are adjacent to each other so as to be flush, the symbol or symbol string is displayed recognizably from the one surface of the first ornament to the one surface of the second ornament.

23. The ornamental article according to claim 21, wherein an upper part of the symbol or symbol string is laid out on a contact surface of the first ornament, and a lower part of the symbol or symbol string is laid out on a contact surface of the second ornament.

24. The ornamental article according claim 21, wherein the at least two surfaces adjacent to each other are substantially perpendicular to each other.

25. The ornamental article according to claim 21, wherein each of the first ornament and the second ornament is a polyhedron,
wherein the polyhedron is a rectangular parallelepiped or cube.

26. The ornamental article according to claim 21, wherein
each of the first ornament and the second ornament is an annular body comprising an outward surface, an inward surface, and a side surface located between the outward surface and the inward surface, wherein the annular body has a symbol or symbol string laid out across at least two surfaces of the outward surface and the side surface, and
in such an arrangement that the outward surface of the first ornament is adjacent to the outward surface of the second ornament, the symbol or symbol string is displayed recognizably from the outward surface of the first ornament to the outward surface of the second ornament.

27. The ornamental article according to claim 26, wherein, in such an arrangement that the outward surface of the first ornament and the outward surface of the second ornament are adjacent to each other so as to be flush, the symbol or symbol string is displayed recognizably from the outward surface of the first ornament to the outward surface of the second ornament.

28. The ornamental article according to claim 26, wherein outer diameters of the respective outward surfaces of the first ornament and the second ornament are equivalent to each other.

29. The ornamental article according to claim 21, wherein
each of the first ornament and the second ornament is an annular body comprising an outward surface, an inward surface, and a side surface located between the outward surface and the inward surface, wherein the annular body has a symbol or symbol string laid out across at least two surfaces of the inward surface and the side surface, and
in such an arrangement that the inward surface of the first ornament and the inward surface of the second ornament are adjacent to each other, the symbol or symbol string is displayed recognizably from the inward surface of the first ornament to the inward surface of the second ornament.

30. The ornamental article according to claim 29, wherein, in such an arrangement that the inward surface of the first ornament and the inward surface of the second ornament are adjacent to each other so as to be flush, the symbol or symbol string is displayed recognizably from the inward surface of the first ornament to the inward surface of the second ornament.

31. The ornamental article according to claim 29, wherein inner diameters of the respective inward surfaces of the first ornament and the second ornament are equivalent to each other.

32. The ornamental article according to claim 21, wherein
each of the first ornament and the second ornament is an annular body comprising an outward surface, an inward surface, and a side surface located between the outward surface and the inward surface, wherein an outer diameter of the first ornament is not more than an inner diameter of the second ornament,
the first ornament has a symbol or symbol string laid out across at least two surfaces of the outward surface and the side surface,
the second ornament has a symbol or symbol string laid out across at least two surfaces of the inward surface and the side surface, and
in such an arrangement that the outward surface of the first ornament and the inward surface of the second ornament are opposed to each other, the symbol or symbol string is displayed recognizably from the side surface of the first ornament to the side surface of the second ornament.

33. The ornamental article according to claim 32, wherein, in such an arrangement that the side surface of the first ornament and the side surface of the second ornament are adjacent to each other so as to be flush, the symbol or symbol string is displayed recognizably from the side surface of the first ornament to the side surface of the second ornament.

34. The ornamental article according to claim 32, wherein a width of the outward surface of the first ornament and a width of the inward surface of the second ornament are equivalent to each other.

35. An ornamental article comprising, a plurality of ornaments each having a symbol or symbol string laid out across a plurality of surfaces adjacent to each other, wherein
in such an arrangement that one surfaces of the plurality of ornaments each having a part of a symbol or symbol string laid out thereon are adjacent to each other, the symbol or symbol string is displayed recognizably on the surfaces adjacent to each other.

36. The ornamental article according to claim 35, wherein an upper part of the symbol or symbol string is laid out on a contact surface of the first ornament, and a lower part of the symbol or symbol string is laid out on a contact surface of the second ornament.

37. The ornamental article according to claim 35, wherein the plurality of surfaces adjacent to each other are substantially perpendicular to each other.

38. The ornamental article according to claim 35, which has a line-intersection portion formed by the plurality of surfaces adjacent to each other.
